(19) United States
(12) Patent Application Publication
(10) Pub. No.: US 2009/0026035 A1
(43) Pub. Date: Jan. 29, 2009

(54) Hybrid Apparatus for Transmitting Motive Power to a Driven Shaft

(76) Inventors: Piercarlo Boffelli, Tribiano (MI) (IT); Claudio Bellotti, Tribiano (MI) (IT); Erminio Depoli, Tribiano (MI) (IT); Fabio Natale, Tribiano (MI) (IT)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/244,823

(22) Filed: Oct. 3, 2008

(30) Foreign Application Priority Data
Mar. 10, 2007 (IT) MI2007A001893

(51) Int. Cl. F16D 27/12

(52) U.S. Cl. 192/48.2; 62/323.4; 903/914

(57) ABSTRACT

Apparatus for transmitting motive power from a combustion engine or from an electric generator/motor to a driven shaft coupled to a rotating device, includes a main shaft having a first end connected to the combustion engine by a first engaging/disengaging device and a second end connected to the driven shaft by a second engaging/disengaging device, said shaft having, mounted thereon, a first electromagnetic clutch, the rotor of which is adapted to selectively receive motive power from a secondary shaft which is connected to the motor/generator, the main shaft being provided with a pulley carrying a drive belt which is wound onto a second pulley mounted idle on said secondary shaft and adapted to transmit motive power to the generator/motor via a third engaging/disengaging device.

### TECHNICAL FIELD OF THE INVENTION

The present invention relates to a hybrid apparatus for transmitting motive power to a driven shaft.

### DESCRIPTION OF THE PRIOR ART

It is known in the technical sector relating to the transmission of motive power to rotating devices that there exists the need to perform rotation of the associated shafts by means of hybrid apparatus which are, for example, operated by a combustion engine or an electric motor.

This need arises for example with regard to the activation, in vehicles, of the air-conditioning compressors which, during normal day-time travel, may be operated by means of a drive shaft connected to the combustion engine, but which also need to be operated during night-time stoppages when the engine is switched off; in this case it is required to have an electric generator/motor connected to batteries and able to cause rotation of the shaft operating the compressor without, however, interfering with the combustion engine, when the latter is running.

### SUMMARY

The technical problem which is posed, therefore, is to provide a hybrid transmission apparatus able to perform rotation of a driven shaft, drawing power either from a combustion engine or from an electric motor.

In connection with this problem it is also desirable that this apparatus should be able to charge electric batteries which in turn must power the electric motor when the combustion engine is switched off.

In addition it is desirable that the apparatus should have compact dimensions, be easy and inexpensive to produce and assemble and if necessary be able to be applied also to already existing devices.

These results are obtained according to the present invention by an apparatus for transmitting motive power from a combustion engine or an electric generator/motor to a driven shaft which is connected to a rotating device according to the characteristic features of the invention8.

### BRIEF DESCRIPTION OF THE FIGURES

Further details may be obtained from the following description of a non-limiting example of embodiment of the subject of the present invention provided with reference to the accompanying drawings in which:

FIG. 1 shows a schematic cross-section along a longitudinal/vertical plane of the apparatus according to the present invention; and

FIG. 2 shows an alternative example of embodiment of the device for connecting the apparatus to the combustion engine.

### DETAILED DESCRIPTION

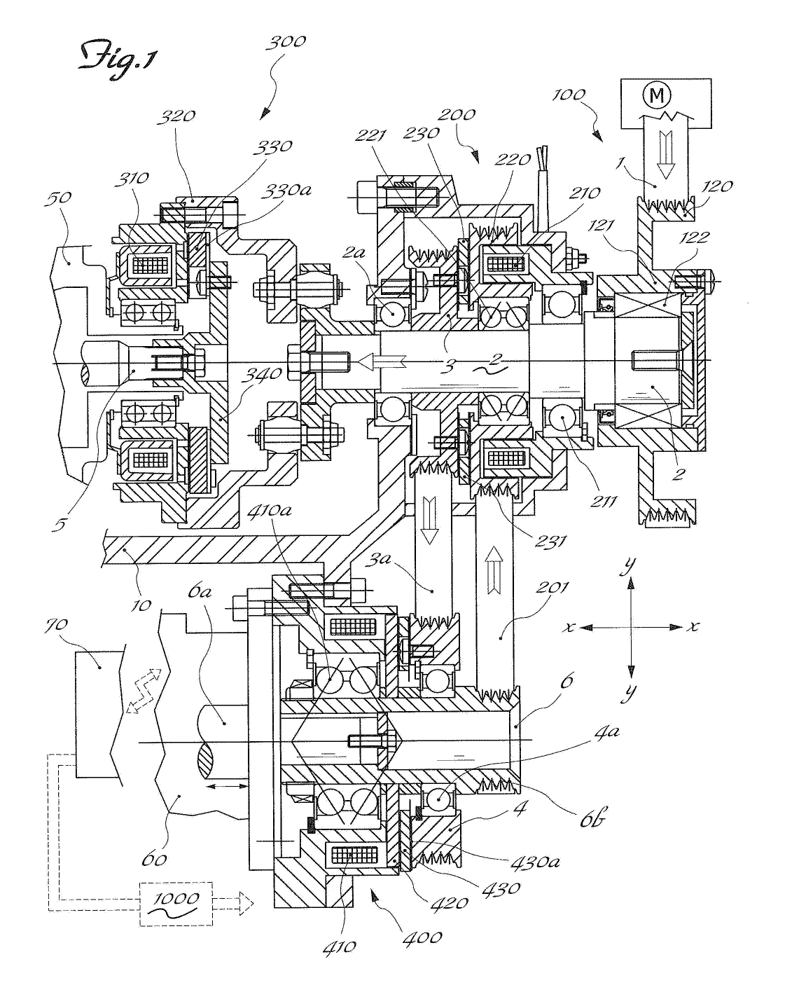

As shown in FIG. 1 and assuming solely for the sake of convenience of the description and without a limiting meaning a pair of reference axes in the longitudinal direction X-X and transverse direction Y-Y, respectively, as well as a front part corresponding to the part for connecting the auxiliary devices and a rear part opposite to the front part, the hybrid apparatus for transmitting the motive power from a main shaft 2 to a driven shaft 5 comprises a fixed structure 10 having, mounted thereon, a bearing 2a which is keyed onto the main shaft 2 which may be rotationally operated by a combustion engine M or by an electric motor which is schematically denoted by 60 with the associated shaft 6a connected in the longitudinal direction to a shaft 6 which is mounted on a bearing 410a which is in turn rigidly coupled with the fixed structure 10.

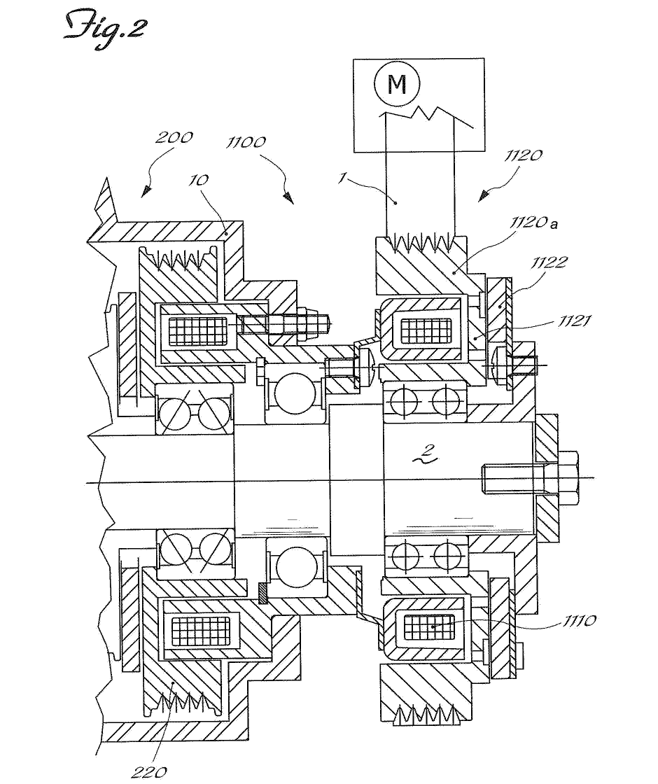

In greater detail the motor M is connected to the shaft 2 by means of a belt 1 which is endlessly wound around a pulley 120 which is coupled with a first engaging/disengaging device, such as a free release mechanism 100 or a clutch 110 (as shown in FIG. 2). The pulley 120 can be coupled to the outer ring 121 of the free release mechanism 100 which also comprises a free wheel 122 which is arranged between the outer ring 121 and the shaft 2 so that up to a certain speed of rotation the shaft 2 receives motive power from the pulley 120, while beyond the speed the free release device prevents transmission of the motive power back to the belt 1 as will be understood more clearly below.

The shaft 2 has, mounted thereon after the free release device 100, a first clutch 200, such as an electromagnetic clutch, comprising a fixed electromagnet 210 mounted between the structure 10 and a bearing 211 which is keyed onto the shaft 2, there being arranged, concentrically with the electromagnet 210, a pulley 220 forming the rotor of the clutch and carrying a belt 201 which is endlessly wound onto a pulley 6b formed on a secondary shaft 6 parallel to the longitudinal direction X-X.

The first clutch 200 also comprises an armature 230 which is connected via a resilient membrane 231 to a third pulley 3 which is rotationally locked to the main shaft 2 and which carries a belt 3a endlessly wound onto a pulley 4 mounted onto a bearing 4a which is keyed onto the secondary shaft 6.

The end of the shaft 2 opposite to that of the free release device has, mounted thereon, an ON/OFF clutch 300, such as an electromagnetic clutch, comprising a fixed electromagnet 310, a rotor 320 connected to the shaft 2 operated by the apparatus, an armature 330 connected to a disk 340 via a resilient membrane 330a able to allow displacement in the longitudinal direction of the armature, while preventing relative rotation.

The armature 330 is recalled against the rotor 320 by excitation of the electromagnet 310.

The disk 340 can be axially coupled to a driven shaft 5 to be rotated and forming part of a rotating device 50 which may, for example, be formed by the air-conditioning compressor of a vehicle.

The armature 430 of an electromagnetic clutch 400 is connected to the pulley 4 of the secondary shaft 6 via a resilient membrane 430a, the clutch comprising a rotor 420 integral with the secondary shaft 6 and an annular electromagnet 410 which is mounted on a bearing 410a keyed onto the secondary shaft 6.

As shown, the shaft 6 is extended in the longitudinal direction beyond the fixed structure 10 by a section 6a forming the shaft of a rotating device 60 which may consist of an electric motor connected to one or more batteries 70.

With such a configuration the operating principle of the hybrid transmission apparatus and the associated rotating devices connected to it is as follows:

Compressor Switched on/Off by Combustion Engine

The shaft 5 of the compressor 50 is normally at a standstill since the electromagnetic clutch 300 is kept disengaged so that rotation of the shaft 2 performed by the combustion engine M is not transmitted to the compressor.

If it is required to activate the compressor it is sufficient to excite the electromagnet 310 of the clutch 300 so as to activate or recall the armature 330 and transmit the motive power from the main shaft 2 to the driven shaft 5 and therefore to the rotating device 50, such as a compressor, which starts to operate.

### Battery Charging

Independently of operation of the compressor 50 it is possible to charge the one or more batteries 70 by means of the electric motor 60 which operates in this case as a generator and is rotated by the belt 3a endlessly wound onto the pulleys 3 and 4 and as an engaging device for the clutch 400 which, exciting the electromagnet 410, activates or recalls the armature 430 against the rotor 420 which is integral with the shaft 6 and is thus rotated together with the extension 6a of the generator 60.

A control unit 1000 is adapted to detect when the one or more batteries 70 are fully charged and deactivate the control circuit of the electromagnet 410 so as to separate the armature 430 and reset the shaft 6 to the idle condition.

Compressor Switched on/Off by Electric Motor

If powering of the compressor 50 independently of the combustion engine M is required, it is possible to cause rotation of the main shaft 2 by means of the secondary shaft 6.

In this case the one or more batteries 70 can power the electric motor 60 which causes rotation of shaft 6a and shaft 6 which, via its pulley 6b and the respective belt 201, causes rotation of the pulley-rotor 220 mounted on the bearing 221 of the shaft 2.

Activation or recall of the armature 230 by means of excitation of the electromagnet 210 of the clutch 200 can cause the rotation of the pulley-rotor 200 to impart motive power to the shaft 2, the motive power being able to be transmitted to the shaft 5 via the clutch 300 as already described further above.

It is therefore clear how the hybrid transmission apparatus according to the present invention allows operation of the driven shaft 5 of a rotating device by means of a combustion engine M or, alternately, by means of an electric motor 60 which is powered by batteries 70, the apparatus also being able to perform recharging of the batteries by means of the combustion engine independently of operation of the driven shaft 5.

In order to limit the size of the electric motor 60 while maintaining the torque necessary for operating the driven shaft 5 of the rotating device (compressor) connected thereto and to be operated, the pulley 6b of the shaft 6 operated by the electric motor 60 and the pulley 220 mounted on the main shaft 2 can include a reduction gear or form a speed reducing mechanism in order to reduce the number of revolutions transmitted by the electric motor, resulting in the greater torque required without altering the dimensions of the electric motor.

In an alternative embodiment of the invention, the connection 1100 between the main shaft 2 and the combustion engine can be performed by means of an electromagnetic clutch 1120 instead of via the free release device 120.

The clutch 1120 comprises an electromagnet 1110, a rotor 1121 integral with the pulley 1120a actuated by the belt 1 of the combustion engine M, and an armature 1122 which can be recalled by excitation of the electromagnet 1110 so as to connect the rotor 1121 to the main shaft 2.

The operating principle of the clutch can be conventional per se and therefore not described in detail; in addition, the engagement/disengagement of the clutch can transmit the motive power to the main shaft or prevent transmission of the motive power back to the belt of the combustion engine.

1. An apparatus for transmitting motive power to a driven shaft coupled to a rotating device, the apparatus comprising
a main shaft having a first portion connected to a combustion engine by a first engaging/disengaging device and a second portion connected to the driven shaft by a second engaging/disengaging device, said main shaft having, mounted thereon, a first electromagnetic clutch, the first electromagnetic clutch including a first rotor coupled to a secondary shaft which is connected to a motor/generator,
the main shaft having mounted thereon a first pulley,
the secondary shaft having mounted thereon a third engaging/disengaging device, the third engaging/disengaging device including a second pulley for transmitting motive power to the secondary shaft through the third engaging/disengaging device; and
a first drive belt connecting the first pulley to the second pulley to transmit motive power to the secondary shaft and the generator/motor through the third engaging/disengaging device.

2. An apparatus according to claim 1, wherein said main shaft is mounted on a bearing rigidly coupled with a fixed structure.

3. An apparatus according to claim 1, wherein said secondary shaft is parallel to the main shaft.

4. An apparatus according to claim 1, wherein said secondary shaft is mounted on a bearing rigidly coupled with the fixed structure.

5. An apparatus according to claim 1, wherein said first engaging/disengaging device is a free release device.

6. An apparatus according to claim 5, wherein said free release device comprises an outer ring carrying a drive pulley and a free wheel arranged between the outer ring and the main shaft.

7. An apparatus according to claim 6, wherein the combustion engine is connected to the shaft via a second drive belt wound onto said drive pulley of the free release mechanism.

8. An apparatus according to claim 1, wherein the combustion engine is connected to the main shaft via an electromagnetic clutch.

9. An apparatus according to claim 8, wherein said electromagnetic clutch comprises an electromagnet, a rotor coupled to a drive pulley actuated by a second drive belt driven by the combustion engine, and an armature which is able to be axially recalled by excitation of the electromagnet.

10. An apparatus according to claim 1, wherein the first electromagnetic clutch is arranged between the first engaging/disengaging device and the second engaging/disengaging device along the main shaft.

11. An apparatus according to claim 1, wherein said first electromagnetic clutch comprises a fixed electromagnet, a first clutch pulley arranged concentrically with the electromagnet and forming a rotor of the first electromagnetic clutch, and an armature connected via a resilient membrane to the first pulley, the first pulley being rotationally locked with the main shaft.

12. An apparatus according to claim 11, wherein said first clutch pulley is connected, via a third belt, to a third pulley coupled to the secondary shaft.

13. An apparatus according to claim 13, wherein the third pulley, coupled to the secondary shaft and operated by the electric motor, and the first clutch pulley, mounted on the main shaft, form a speed reducing mechanism.

14. An apparatus according to claim 1, wherein the second pulley is mounted on a bearing and the bearing is keyed to said secondary shaft.

15. An apparatus according to claim 14, wherein said pulley of the main shaft is arranged between the first electromagnetic clutch and the second engaging/disengaging device along the main shaft.

16. An apparatus according to claim 1, wherein said second engaging/disengaging device is an ON/OFF clutch.

17. An apparatus according to claim 16, wherein said ON/OFF clutch is an electromagnetic clutch.

18. An apparatus according to claim 17, wherein said ON/OFF clutch is an electromagnetic clutch comprising a fixed electromagnet, a rotor connected to the main shaft, and an armature connected to a disk via a resilient membrane.

19. An apparatus according to claim 1, wherein said third engaging/disengaging device mounted on the secondary shaft is an electromagnetic clutch.

20. An apparatus according to claim 19, wherein the third engaging/disengaging device is an electromagnetic clutch comprising a rotor coupled to the secondary shaft, an annular electromagnet mounted on a bearing keyed onto the secondary shaft and an armature connected to the pulley via a resilient membrane.

21. An apparatus according to claim 1, wherein said electric motor/generator is connected to at least one rechargeable battery.

22. An apparatus according to claim 21, further comprising a control unit connected to said at least one rechargeable battery and connected to a control circuit of the third engaging/disengaging device and adapted to detect when the at least one rechargeable battery is fully charged and for disengaging the third engaging/disengaging device.

23. An apparatus according to claim 1, wherein said rotating device is an air-conditioning compressor of a vehicle.
